(19) United States
(12) Patent Application Publication
(10) Pub. No.: US 2022/0162481 A1
(43) Pub. Date: May 26, 2022

(54) Polyolefin Composition Comprising Polydioorganosiloxane Block Copolymer Having C16-C70 Alkyl Block Suitable for Release Coating and Pressure Sensitive Adhesive Article

(71) Applicant: 3M INNOVATIVE PROPERTIES COMPANY, St. Paul, MN (US)

(72) Inventors: Jitendra S. Rathore, Woodbury, MN (US); Maria A. Appeaning, St. Paul, MN (US); Georgiy Teverovskiy, St. Louis Park, MN (US); Marie A. Boulos, West St. Paul, MN (US); Chris J. Tanley, Stillwater, MN (US); Kacy N.M. Rainey, Cottage Grove, MN (US)

(21) Appl. No.: 17/431,929

(22) PCT Filed: Apr. 8, 2020
(86) PCT No.: PCT/IB2020/053363

§ 371 Date: Aug. 18, 2021

Related U.S. Application Data
(60) Provisional application No. 62/836,160, filed on Apr. 19, 2019.

(51) Int. Cl. C09J 7/38; C09J 7/40; C08L 23/08; C08G 77/442; C08G 77/12; C08G 77/08

(52) U.S. Cl. CPC C09J 7/38; C09J 7/401; C08L 23/08; C08G 77/442; C09J 2453/005; C08G 77/08; C09J 2301/302; C09J 2423/045; C08G 77/12

(57) ABSTRACT

A pressure sensitive adhesive article is described comprising a pressure sensitive adhesive in contact with the release layer. The release layer comprises a thermoplastic polymer and a block copolymer additive having the general structure: A[LB]n wherein A is a polyorganosiloxane block, L is a covalent bond or a divalent linking group B is independently a C16-C70 alkyl group, and n is at least 1. In other embodiments, compositions are described comprising a thermoplastic polymer the described block copolymer additive; as well as methods of making a release composition.

### SUMMARY

In one embodiment, a pressure sensitive adhesive article is described comprising a a release layer and a pressure sensitive adhesive in contact with the release layer. The release layer comprises a thermoplastic polymer and a block copolymer additive. The block copolymer additive has the general structure:

A[LB]n

wherein
A is a polyorganosiloxane block,
L is a covalent bond or a divalent linking group
B is independently a C16-C70 alkyl group, and
n is at least 1.

In another embodiment, a composition is described comprising a thermoplastic polymer; and up to 50 wt. % of a block copolymer additive; wherein the block copolymer additive has the general structure described above.

In another embodiment, a composition is described comprising a thermoplastic polymer; and up to 50 wt. % block copolymer additive; wherein the block copolymer additive is the reaction product of a polydiorganosiloxane polymer comprising a terminal functional group and an (e.g. alpha or poly)olefin material having a specific gravity no greater than 0.89.

Also described is a method of making a release composition comprising: melting processing a composition comprising a thermoplastic polymer and block copolymer additive as described herein.

### DETAILED DESCRIPTION

Presently described are compositions comprising thermoplastic polymer and a block copolymer additive. The compositions are suitable for use as a release layer of pressure sensitive adhesive articles. Release coatings of tapes are often referred to as a low adhesion backsize (“LAB”) coating.

The block copolymers comprise at least one polyorganosiloxane block and at least one hydrocarbon block.

The block copolymer typically has the structure:

A[LB]ₙ

wherein A is a polyorganosiloxane block, B is independently a C16-C70 alkyl group, and L is a covalent bond or a divalent (e.g. organic) linking group.

In some embodiments, n is 1, and the block copolymer can be characterized as having a linear diblock (A-B) structure. In other embodiments, n is 2 and the block copolymer can be characterized as having a linear triblock (B-A-B) structure wherein B are polyolefin (e.g. C16-C70) endblocks and A is the polyorganosiloxane midblock.

The block copolymer additive is typically prepared by reaction of a polydiorganosiloxane having one or more terminal functional groups that polymerize with an alpha olefin material or functional polyolefin material.

In some embodiments, the block copolymer additive is prepared by reaction of an alpha olefin and a polydiorganosiloxane having a functional group or groups that polymerize with the unsaturation of the alpha olefin. An alpha-olefin (or α-olefin) is an alkene where the carbon-carbon double bond starts at the α-carbon atom, i.e. the double bond is between the #1 and #2 carbons of the molecule.

In some embodiments, the polydiorganosiloxane is a hydride terminated poly(dimethylsiloxane) having the general formula:

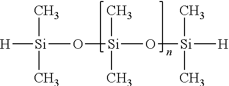

wherein n is the number of dimethylsiloxane repeat groups.

Various (e.g. hydride) functional polydiorganosiloxane materials are commercially available from various supplied such as Gelest. The hydride content can range from about least 0.001, 0.002, or 0.003% up to 0.5% or 1%.

One of ordinary skill in the art appreciates that hydride functional siloxane reacts via hydrosilylation with the unsaturated double bond of an alpha olefin in the presence of a (e.g. platinum) catalyst. In such reaction scheme, the alpha olefin material is typically heated (100° C.) until molten and then the functional polydiorganosiloxane material and a catalyst is added. The reaction mixture is maintained at elevated temperature and monitored by FT-IR until the disappearance of the Si—H absorbance. An organic solvent may optionally be present such as heptane, hexane, cyclohexane, benzene, toluene, or xylene. Alternatively, molten alpha olefin material can be reacted with the (e.g. hydride) functional polydiorganosiloxane at an elevated temperature in the absence of a solvent.

In other embodiments, the block copolymers additives can be prepared by reacting an amine-functional polyorganosiloxane with an acrylate functional polyolefin.

The amine-functional polyorganosiloxane can be prepared by a variety of methods. Methods of synthesizing such materials are described in U.S. Pat. No. 5,214,119 and U.S. Pat. No. 6,355,759. Various amine-functional polyorganosiloxane materials are commercially from Gelest Inc., Morrisville Pa.; Wacker Chemie AG, Munich Germany; and Genesse Polymer Corporation, Burton, Mich. The amine content can range from about least 0.01, 0.02, 0.03, 0.04, or 0.05% up to 0.5, 11.5, 2, 2.5, 3, 3.5, or 4%.

In some embodiments, the polydiorganosiloxane is an amino alkyl terminated poly(dimethylsiloxane). The alkyl spacer group between the polydiorganosiloxane backbone and amine end group can range in chain length from C1-C12. In some embodiments, the chain length of the alkyl spacer group is no greater than C10, C8, C6 or C4.

A representative example of aminopropyl terminated polydimethylsiloxane has the general formula:

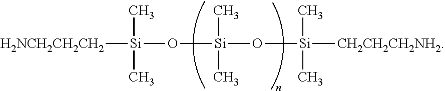

One of ordinary skill in the art appreciates that the number of dimethylsiloxane repeat groups (“n” of the above representative structure) can also be expressed in terms of molecular weight. Unless specified otherwise, throughout the application “molecular weight” refers to the number average molecular weight. The molecular weight of the polyorganosiloxane block is typically at least 200 g/mole, 300 g/mole, or 400 g/mole. The molecular weight of the polyorganosiloxane block is typically no greater than 200,000 g/mole; 175,000 g/mole; 150,000 g/mole; 125,000 g/mole; or 100,000 g/mole. In some embodiments, the molecular weight (Mn) of the polyorganosiloxane block is no greater than 90,000 g/mole or 80,000 g/mole or 70,000 g/mole. In some embodiments, the polyorganosiloxane block is at least 500 g/mole, 700 g/mole, 700 g/mole, 800 g/mole, 900 g/mole, or 1000 g/mole. In some embodiments, the molecular weight of the polyorganosiloxane block is at least 2000 g/mole, 3000 g/mole, 4000 g/mole, or 5,000 g/mole. In some embodiments, the molecular weight of the polyorganosiloxane block is at least 10,000 g/mole or 15,000 g/mole. In some embodiments, the molecular weight of the polyorganosiloxane block is at least 20,000 g/mole or 25,000 g/mole. In some embodiments, the molecular weight of the polyorganosiloxane block is at least 30,000 g/mole; 35,000 g/mole; 45,000 g/mole; or 50,000 g/mole.

In some embodiments, the molecular weight (Mn) of the polyorganosiloxane block is no greater than 60,000 g/mole; 55,000 g/mole; 50,000 g/mole; 45,000 g/mole; 40,000 g/mole; 35,000 g/mole; or 30,000 g/mol. In some embodiments, the molecular weight (Mn) of the polyorganosiloxane block is no greater than 25,000 g/mole or 20,000 g/mole. In some embodiments, the molecular weight (Mn) of the polyorganosiloxane block is no greater than 15,000 g/mole or 10,000 g/mole. In some embodiments, the molecular weight (Mn) of the polyorganosiloxane block is no greater than 5,000 g/mole.

The equivalent weight of the various functional polydiorganosiloxane materials, i.e. molecular weight per functional group, is the molecular weight (Mn) described above divided by two.

Various (e.g. alpha or poly) olefin materials can be utilized in the preparation of the block copolymer. In some embodiments, the alpha olefin or functional polyolefin material may comprise a single alkyl group such as a C30.

In other embodiments, the (e.g. alpha or poly) olefin material may comprise a mixture of chain lengths, typically ranging from 16 to 70 carbon atoms. Thus, “B” of the block copolymer additive may comprise two different alkyl groups such as alkyl groups of different chain lengths. When different chain lengths are present, the chain length may be expressed as an average chain length. In some embodiments, the average chain length of the alkyl groups of the block copolymer additive is at least 16, 18, or 20. In some embodiments, the average chain length of the alkyl groups of the block copolymer additive is at least 22, 24, 26, 28 or 30.

In some embodiments, the alkyl groups of the block copolymer additive comprise 1-96 wt. % of alkyl groups having less than 30 contiguous carbon atoms. For example, when the block copolymer additive is prepared from behenyl acrylate, the “B” block independently has chain length of 18, 20, and 22 carbon atoms. In some embodiments, concentration of alkyl groups having 18 or 22 carbon atoms may range from 35 to 50 wt. %. In some embodiments, the concentration of alkyl groups having 20 carbon atoms may range from 5 to 20 wt. %.

In some embodiments, the alkyl groups of the block copolymer additive comprise 1-96 wt. % of alkyl groups having at least 30 contiguous carbon atoms. In some embodiments, the alkyl groups of the block copolymer additive comprise 1-10 wt. % of alkyl group having at least 30 contiguous carbon atoms and at least 90-99 wt. % of alkyl groups having 26-28 contiguous carbon atoms. In other embodiments, the alkyl groups of the block copolymer additive comprise 1-10 wt. % of alkyl groups having 24-28 contiguous carbon atoms and at least 90-99 wt. % of alkyl group having at least 30 contiguous carbon atoms. In some embodiments, the starting (e.g. alpha olefin) material comprises small concentration of olefins or (e.g. saturated) polyolefins having a chain length less than 20 or greater than 70. In some embodiments, the concentration of such is typically less than 5, 4, 3, 2, or 1 wt. % of the alpha olefin material.

In some embodiments, the starting (e.g. alpha or poly) olefin material comprises linear and branched alkyl groups. In some embodiments, the starting material comprises at least 5, 10 or 15 wt. % of branched olefins or alkyl group, typically ranging up to 30 or 35 wt. % of branched olefins or alkyl groups. In some embodiments, the starting material comprises no greater than 25, 24, 23, 22, 21, or 20 wt. % of branched olefins or alkyl groups. Thus, “B” of the block copolymer additive may comprise two different alkyl groups such as a linear alkyl group and a branched alkyl group.

The starting (e.g. alpha or poly) olefin material is typically a solid at 15, 20, 25, 30 ,35 or 40° C. In some embodiments, the starting material has a specific gravity (as determined by ASTM D 287) at 15 or 25° C. of no greater than 0.88, 0.87, 0.86, 0.85, 0.84, 0.83, 0.82, 0.81, 0.80 g/cc. The specific gravity is typically at least 0.75 g/cc.

In some embodiments, the starting (e.g. alpha olefin) material has a congealing point (as determined with ASTM D 938) of at least 120, 130, 140 or 150° F. The starting (e.g. alpha olefin) material may have a penetration (0.10 mm, as determined with ASTM D 1321) of less than 200, 175, 150, 125, 100, 75, or 50 at 110° F.(43.3° C.). In some embodiments, the starting (e.g. alpha olefin) material may have a penetration of less than 125, 100, 75, or 50 at 100 F (37.8 C). In some embodiments, the starting (e.g. alpha olefin) material may have a penetration of less than 75, 50, or 25 at 77° F. (25° C.). In some embodiments, the alpha olefin material comprises at least 65, 70, or 75 wt. % of n-alpha olefin (as determined with Nuclear Magnetic Resonance). In some embodiments, the amount of n-alpha olefin is no greater than 90 or 85 wt. % of the alpha olefin material. Thus, the alpha olefin material may comprise at least 5, 10, 15, 20, 25, 30 or 35 wt. % of other olefins and/or (e.g. saturated) C16 to C70 polyalkylenes. This fraction may not react with the (e.g. hydride) functional polydiorganosiloxane and may be present as a by-product. The alpha olefin material may comprise small concentration of oil. For example, the oil content may be less than 5, 4, 3, 2, or 1 wt. %. In some embodiments, the by-product(s) and oil can be removed from the block copolymer additive, such as by solvent extraction, prior to reacting with the (e.g. hydride) functional polydiorganosiloxane or after synthesis of the block copolymer additive.

Suitable alpha olefin materials include for example ALPHAPLUS® C30+, ALPHAPLUS® C30+HA, and ALPHAPLUS® C26-28 available from Chevron Phillips Chemical Company LP of The Woodlands, Tex. Suitable functional polyolefin materials include alkyl acrylates such as Behenyl Acrylate 1822 from BASF.

In some embodiments, the molecular weight of the block copolymer additive is approximately equal to the sum of the molecular weight of the (e.g. hydride) functional polydiorganosilane, as described above, and the molecular weight of the C16-C70 alkyl group(s). In the case of a diblock comprising one polydioorganosiloxane block and one C16-C70 alkyl group, the alkyl group increases the molecular weight of the functional polydiorganosilane by about 165 to 980 g/mole or about 330 to 1960 g/mole in the case of a triblock.

In other embodiments, the molecular weight of the block copolymer additive is approximately equal to the sum of the molecular weight of the (e.g. amino) functional polydiorganosilane, as described above, the molecular weight of the C16-C70 alkyl group(s), and the molecular weight of the (e.g. divalent) organic linking group. The linking group typically has a molecular weight no greater than 250, 225, 200, or 175 g/mole.

The block copolymer additive is blended with a thermoplastic resin using conventional melt processes and apparatuses to form a release composition blend. The thermoplastic resin employed to form the release blend is not particularly limited; however, the thermoplastic resin is typically sufficiently compatible to form a release blend in a melt blending process with the block copolymer additive described above. Suitable thermoplastic resins employed to form the release blends include, for example, linear or branched polyolefins. Exemplary polyolefins include, but are not limited to polyethylene, polypropylene, poly-α-olefins, and copolymers thereof, including low density polyethylene (LDPE), high density polyethylene (HDPE), linear low density polyethylene (LLDPE), ultra-high density polyethylene (UHDPE), and polyethylene-polypropylene copolymers, as well as polyolefin copolymers having non-olefin content (that is, content derived from monomers that are not olefins). The non-olefin content of polyolefin polymers employed in some embodiments is not particularly limited, but includes, for example, 1-5 wt % of acrylic acid, or methacrylic acid functionality, including sodium, zinc, or calcium salts of the acid functionality; 1-5 wt % of an anhydride functionality, such as maleic anhydride, or the corresponding ring-opened carboxylate functionality; and the like. In some embodiments, blends of polyolefins containing non-polyolefin content are blended at various ratios with polyolefins in order to provide a targeted level of non-olefin content. Also useful are polymers and copolymers of conjugated diene monomers, such as polybutadiene or isoprene; and blends or alloys of these. Also useful are polyesters, polyurethanes, polyamides, polystyrene and copolymers thereof, including block copolymers thereof, and the like, and their blends or alloys with polyolefins and copolymers thereof. Useful polymers and blends further include recycled blends of commingled thermoplastic waste streams, and blends of recycled polymers with virgin polymers. In some embodiments, the thermoplastic (e.g. polyolfin) polymer has a melt index of less than 20, 15, 10, or 5 g/10 min at 190° C. (2.16 kg ASTM D 1238)

In some embodiments, the block copolymer additive is blended with the thermoplastic resins in an amount of about 0.1 wt % to 10 wt % based on the total weight of the release layer or release composition. In some embodiments, the amount of block copolymer additive is at least 0.1, 0.2, 0.3, 0.4, 0.5, 0.6, 0.7, 0.8, 0.9, or 1 wt. % of the release layer or composition. In some embodiments, the amount of block copolymer additive is no greater than 9, 8, 7, 6, 5, or 4 wt. % of the release layer or composition.

The release layer or composition typically comprise 90 to 99.9 wt. % of thermoplastic (e.g. polyolefin) polymer based on the total weight of the thermoplastic polymer and block copolymer additive (i.e. excluding other optional additives). In some embodiments, the amount of thermoplastic (e.g. polyolefin) polymer is at least 91, 92, 93, 94, 95, 96, 97, 98, or 99 wt. % based on the total weight of the thermoplastic polymer and block copolymer additive.

In other embodiments, the block copolymer additive are compounded (e.g. initially in a masterbatch) composition having a higher concentration of block copolymer additive. For example, the masterbatch composition may comprise up to 15, 20, 25, 30, 35, 40, 45, or 50 wt. % of the block copolymer additive described herein.

The masterbatch may be processed into a form that is easily storable or shippable, such as pellets, flakes, granules, and the like. In another embodiment, a masterbatch may be formed by solution coating pellets, flakes, or granules of a thermoplastic with a solution of the bloc copolymer additive described herein and drying the solvent. The masterbatch is later blended with a thermoplastic polymer to form a release composition or layer having a lower amount of block copolymer additive as described above.

In some embodiments, the (e.g. release) composition optionally further include one or more additives. For example, in embodiments, the additives include one or more UV stabilizers, thermal stabilizers, fillers, colorants, UV or fluorescent dyes, antimicrobial compositions, crosslinkers, solvents, plasticizers, mixtures of two or more thereof, and the like. The one or more additives typically can be present in the composition in amounts ranging from about 0.01 wt % to 10 wt % based on the total composition and may depend on the type of additive and the final properties of the release blend desired. In some embodiments, the amount of additives is no greater than 9, 8, 7, 6, 5, 4, 3, 2, or 1 wt. % of the composition.

Any equipment may be used for melt blending of the thermoplastic polymer with the block copolymer additive alone or in combination with other optional additives as just described. Suitable equipment includes kneaders and extruders. Extruders include single screw and twin-screw extruders. Temperature profiles employed to form the release blends are selected based on the type of thermoplastic resin employed to form the release blends and often according to the supplier's guidelines for melt processing. In some embodiments, it is desirable to employ a twin-screw extruder to form a masterbatch, or a release layer, wherein an intensive mixing screw design is employed. Such screw designs lead, in embodiments, to optimal mixing of the block copolymer additive with the thermoplastic in the extruder barrel. The selected block copolymer additive is added as-is or in masterbatch form to the thermoplastic resin, optionally in addition to one or more additives, to form a release blend. The block copolymer additive can be added as a (e.g. molten) liquid or a solid to the thermoplastic resin to form a release layer or a masterbatch. Liquid delivery is accomplished by pre-heating the bloc copolymer additive, for example via a heated delivery means such as a heated gear pump and transfer line leading to the apparatus, where the molten thermoplastic resin is contacted with the liquid block copolymer additive and the components are blended to form the release blend or the masterbatch.

In some embodiments, solid delivery to form a release layer or a masterbatch is accomplished by feeding the thermoplastic resin and the block copolymer additive separately into the melt blending apparatus, wherein the block copolymer additive is in a flake, pellet, chip, granule, or powder form. In other embodiments, the block copolymer additive is admixed with pellets of the thermoplastic resin and the admixture is fed into the melt blending apparatus.

The (e.g. release) composition described herein can be used to make release layers. In some embodiments, a release layer is formed as a single layer. In some embodiments, the release blends are coextruded with one or more additional layers to form a multilayer construction, wherein the one or more additional layers include at least one layer contacting the release layer that is substantially free of the block copolymer additive. Each of the one or more additional layers in a coextruded release construction include one or more thermoplastic resins, wherein the useful thermoplastic resins include any of those described above. In some embodiments, one or more additional layers include the same thermoplastic resin or blend of thermoplastic resins used to form the release blend. In some embodiments, one or more additional layers include one or more thermoplastic resins that are different from one or more of the thermoplastic resins used to form the release blend. In embodiments, one or more additional layers include one or more additives, such as any of those additives described above. The additive or mixture thereof may be the same or different from the one or more additives included in the release blend. For example, in one representative embodiment, the release layer is free of fillers and colorants, whereas an additional layer includes a filler and a colorant. Other examples will be readily apparent to one of skill.

In some embodiments, one or more additional layers of a multilayer construction are tie layers. Tie layers are employed in some embodiments to impart or improve layer-to-layer adhesion in multilayer constructions, or to impart adhesion between a layer and a substrate onto which the layer is extruded (that is, an extrusion coated layer). For example, anhydride, hydroxyl, and carboxyl functional polymers such as ethylene-vinyl acetate copolymers, ethylene-vinyl alcohol copolymers, ethylene-acrylic acid copolymers, or ethylene-maleic anhydride copolymers are commonly employed in tie layers to provide effective interlayer adhesion between, e.g., a polyolefin layer and a layer including a more polar polymer, such as a polyester; or between two different polyolefin layers.

In some embodiments, polyolefins are mixed with functional olefin copolymers commonly employed as tie layers, and this blend is employed in a single layer or multilayer construction of the invention. Such blends exhibit melt adhesion to paper substrates, such as kraft paper, at lower extrusion temperatures.

Coextrusion is well known in the art as the process of extruding two or more materials through a single die, with a feedblock or die having two or more orifices arranged so that the extrudates merge and contact each other in a laminar structure prior to cooling and solidifying. The laminar structure includes two or more layers, wherein at least one major surface of each layer is disposed in touching relation to a major surface of another layer. Each material is fed to the die from a separate extruder. In embodiments, the orifices are arranged so that each extruder supplies one layer of the same material to the feedblock or die. The feedblock or die is capable of forming two, three, or more laminar layers, with molten materials flowing from source extruders to the orifices in a nearly endless range of configurations. In various embodiments, coextrusion is employed in blown film formation, cast film formation, and extrusion coating of a substrate that is passed beneath the laminar coextrudate as it exits the die. An advantage of coextrusion is that each layer of the laminate imparts a desired characteristic property, such as stiffness, heat-sealability, impermeability or resistance to some environment, the combination of which would be difficult to attain with any single material.

In some embodiments, coextrusion is employed to form a two-layer construction, wherein one layer of the construction is a release layer, and the other layer is substantially free of block copolymer additive. While not limited to such constructions, the methods of the invention are suitably represented by the principles employed in forming a two-layer construction. Employing coextrusion, the location and migration of the block copolymer additive in the release layer is controlled in such a manner that the block copolymer additive is concentrated at the air-release layer interface by the time the laminar construction is solidified. The block copolymer additive is mobile in the molten polymer of the release blend and is capable of migrating within the release layer during the time the layer is molten.

In some embodiments, the release constructions include a substrate, wherein the substrate is an article, a sheet, a film, or a layer that is not coextruded along with the release layer construction, but rather is provided for the purpose of extrusion coating a release layer or multilayer construction thereon. Examples of suitable substrates include paper or other cellulose based substrates such as cardboard, thermoset substrates, nonwoven media, foamed media, irregularly shaped articles, articles, sheets, or layers having an adhesive coated thereon, elastic members, and the like. Suitable examples of paper substrates include kraft paper, alkaline paper, antique paper, bond paper, glassine paper, newsprint paper; coated and uncoated versions thereof; and calendared and uncalendared versions thereof. In some embodiments, a substrate is surface treated to increase effective adhesion of the release layer or multilayer construction thereto. Examples of suitable surface treatments include corona treatment, flame treatment, plasma treatment, physical roughening such as sanding or sandblasting, solvent coating of tie layer-type polymers, chemical etching, embossing, and the like.

In an exemplary set of embodiments, a two-layer construction is coextruded and dispensed from the extrusion die onto a substrate, such as kraft paper. In some such embodiments, the layers are coated in a configuration wherein the first layer contacts the (e.g. paper) substrate, and the second layer is the release layer, wherein the first layer is disposed between the release layer and the (e.g. paper) substrate. In some such embodiments, the thermoplastic included in the release layer is the same thermoplastic as included in the first layer and the first layer does not include block copolymer additive as dispensed via the extruder feed. In another representative embodiment, a three-layer construction has a first layer, a second layer that is a release layer, and one or more additional layers disposed between the first and second layers that are tie layers, that is, layers that provide for interlayer adhesion to effectively adhere the first and second layers. In some such embodiments, the three-layer construction is disposed on a substrate. In some such embodiments, the first layer is further functionalized, or includes one or more additional materials, to increase adhesion of the first layer to the substrate.

In yet another set of representative embodiments, a two-layer construction is formed wherein a first layer is the release layer, and a second layer is an extrudable pressure sensitive adhesive composition. In some such embodiments, the construction is wound upon itself in a tape roll format. In yet another representative embodiment, a three-layer construction is formed wherein a first layer is a release layer, a second layer contiguous to the release layer acts as a tape backing, and a third layer contiguous to the second layer is an extrudable adhesive composition. In some such an embodiment, the construction is wound upon itself in a tape roll format. In a related embodiment, one or more tie layers are disposed between the release layer and the tape backing layer, or between the tape backing layer and the adhesive layer, or between both the release layer/tape backing layer and the tape backing layer/adhesive layer to increase layer-to-layer adhesion.

In yet another set of representative embodiments, a multilayer construction is formed having two or more layers, one of which is the release layer. After formation of the multilayer construction, a pressure sensitive adhesive (PSA) composition is formed atop the major surface of the release layer. For example, the PSA is applied by coating a liquid PSA formulation directly onto the release layer surface and the PSA is solidified. Solidification includes, for example, radiation curing of a mixture of radiation polymerizable monomers, or evaporation of solvent from a PSA in solution. In embodiments where evaporation of solvent is required, heat is further employed in the application of the PSA to the release layer surface. In some such embodiments, a backing layer is subsequently applied to the major surface of the solidified PSA layer to form a completed tape construction; the release layer is peeled away from the PSA when a user is ready to apply the PSA to a target surface. In such embodiments where radiation polymerization is employed, a PSA is formed atop the major surface of the release layer by coating a formulation including a mixture of radiation curable monomers—such as acrylic acid and an alkyl acrylate—on top of the release layer, and exposing the monomer mixture to radiation in order to polymerize and optionally crosslink the monomers to form a PSA. A photoinitiator is employed in some such embodiments to facilitate initiation of the polymerization. A tape backing layer is added to the major surface of the PSA either after cure, or before cure provided that the backing is transparent to the type of radiation employed. In still other embodiments, a PSA is formed by coating a formulation including a mixture of radiation curable monomers on a backing that is not a release layer surface, contacting the formulation with a release layer surface, and exposing the monomer mixture to radiation in order to polymerize and optionally crosslink the monomers to form a PSA. In such embodiments, the release construction including the release layer is at least partially transparent to the radiation employed to polymerize the monomer mixture. In some embodiments where radiation polymerization is employed, the monomer mixture further includes one or more polymers or prepolymers in order to provide increased viscosity.

In yet another set of representative embodiments, the release layer is embossed with a pattern to form an embossed release layer. The embossed release layer is a single layer, part of a multilayer construction, a single or multilayer construction on a substrate (such as a paper or film substrate). Embossed or microembossed patterns useful in conjunction with the release layers of the invention are not particularly limited. In some embodiments, the embossed pattern is the same as or similar to the patterns described U.S. Pat. Nos. 5,362,516; 5,897,930; and 6,197,397. In some embodiments, an adhesive is applied in liquid form to the embossed release layer and subsequently solidified by polymerization, crosslinking, cooling, or solvent evaporation such that the inverse of the pattern of the embossed release layer is imparted to the adhesive. In some such embodiments, the adhesive is thereby provided with, e.g., channels for air bleed during application of the adhesive to the intended, or some other functionality. In some embodiments, an embossed release layer is further coated with a bead composition before or after the embossing; in some embodiments such embossed and coated release layers are further embossed with, e.g., air bleed channel pattern. Suitable bead compositions, as well as methods of coating embossed release liners, are described, for example, in U.S. Pat. No. 5,362,516. The beads, when subsequently contacted with an adhesive, adhere to the adhesive when the adhesive is peeled off the release layer. The beads impart repositionability or control of initial adhesion level when the adhesive is subsequently contacted with the intended adherend.

In some embodiments, the method of forming the release layer is characterized by the absence of post-treatment of the release layers in order to form a release surface. Thus, a simple extrusion, coextrusion, extrusion coating, and optional stretching, embossing, or the like, are adequate to form a release surface from a molten release blend without any annealing or other special operation to improve or bring about the release characteristics of the release layer.

In some conventional techniques employed to form release surfaces, annealing is utilized. Annealing is a thermal post-treatment of a film having the block copolymer additive incorporated therein wherein the film is held at an elevated temperature for a period of time in order to form a film surface having release characteristics. In some embodiments the conventional techniques of annealing include holding a film at temperatures of about 100° C. to 150° C. for about 10 minutes to 30 minutes. In other conventional techniques employed to form release surfaces using block copolymer additive, the molten film is passed over a chill roll having a low surface energy surface—such as a fluoropolymer—in order to form release surfaces.

The thickness of the various single layer and multilayer constructions described herein is not particularly limited, and is selected based on the particular end use and further as limited by the constraints of melt processing equipment employed to form and optionally stretch the constructions prior to solidification thereof. In some such embodiments, the layers—either as single layers or as a layer in a multilayered construction—are at least 10, 15, 20, 25, 30, 35, 40, 45, or 50 microns (2 mils) ranging up to 1 cm thick as extruded.

In some embodiments, a release layer with the block copolymer additive is formed having a release force from a pressure sensitives adhesive test tape less than the same thermoplastic layer lacking the block copolymer additive. The release force is measured according to the test method described in the examples. Although the release force can vary depending on the testing tape, the inclusion of the block copolymer additive described herein generally reduces the release force by at least 50, 55, 60, 65, 70, 75, 80, 85, 90, or 95% relative to the same thermoplastic layer lacking the block copolymer additive.

In one embodiment, the testing tape comprises a (e.g. organic solvent solution coated) iso-octyl acrylate-acrylic acid (90:10) copolymer at a thickness of 0.03 mm on a 0.05 mm polypropylene backing.

In this embodiment, the release force of a thermoplastic (e.g. low density polyethylene) layer alone can be about 400-450 grams/inch. However, by inclusion of small concentrations of the block copolymer additive described herein, the release force is no greater than 350, 300, 250, or 200 grams/inch and in some embodiments, the release force is no greater than 150, 140, 130, 120, 110, 100, 90, 80, 70, 60, 50 40, 30, 20, or 10 grams/inch.

In some embodiments, such as in the case of low adhesion backsizes for tape, the release force may be at least 30, 35, 40, 45, 50, 55, 60, 65, 70, 75, 80, or 85 grams/inch (1-3 ounces/inch) such that the tape remains wound in a roll.

Readhesion and retention of peel strength can be determined according to the test method described in the examples. The retention of peel strength is typically at least 50, 60, 70 or 75%. In some embodiments, the readhesion is at least 80, 85, 90, 95, or 100%. The high readhesion retentions levels observed in many embodiments of the release layers described herein is due to low to substantially no transfer of release materials to the PSAs, as well as a substantial lack of transfer of PSA from the tape to the release layer. Another key aspect of performance is that the block copolymer additive do not cause substantial transfer of adhesive materials, such as plasticizers or tackifiers, into the release layer.

This invention is further illustrated by the following examples which are not intended to be limiting in scope. Unless indicated otherwise, the molecular weights refer to number average molecular weights. All parts, percentages and ratios are by weight unless otherwise specified.

### EXAMPLES

Unless otherwise noted or readily apparent from the context, all parts, percentages, ratios, etc. in the Examples and the rest of the specification are by weight.

TABLE 1
Materials used in the Examples

| Abbreviation | Description and Source |
|---|---|
| PDMS 1 | A hydride terminated polydimethylsiloxane, |
| | obtained under the product code DMS-H31 |
| | from Gelest, Morrisville, PA. |
| PDMS 2 | A hydride terminated polydimethylsiloxane, |
| | obtained under the product code DMS-H21 |
| | from Gelest, Morrisville, PA. |
| PDMS 3 | A hydride terminated polydimethylsiloxane, |
| | obtained under the product code DMS-H11 |
| | from Gelest, Morrisville, PA. |
| PDMS 4 | A hydride terminated polydimethylsiloxane, |
| | obtained under the product code DMS-H03 |
| | from Gelest, Morrisville, PA. |
| PDMS 5 | A hydride terminated polydimethylsiloxane, |
| | obtained under the product code MCR-H21 |
| | from Gelest, Morrisville, PA. |
| PDMS 6 | An aminopropyl terminated |
| | polydimethylsiloxane, obtained under the |
| | product code DMS-A21 from Gelest, |
| | Morrisville, PA. |
| PDMS 7 | A hydride terminated polydimethylsiloxane, |
| | obtained under the product code DMS-H41 |
| | from Gelest, Morrisville, PA. |
| PMHS | Polymethylhydrosiloxane, obtained under the |
| | product code 81330 from Sigma Aldrich |
| | Chemical Company, Milwaukee, WI. |
| Tape 850 | 3M Polyester film 850 Tape, 3M Corporation, |
| | Maplewood, MN. |
| Testing Tape 1 | Iso-octyl acrylate-acrylic acid (90:10) |
| | copolymer was prepared as a solution |
| | in ethyl acetate and heptane. The copolymer |
| | solution was coated on 2.0 mil (0.05 mm) |
| | polypropylene backing and dried to yield a |
| | adhesive coating thickness of 1.4 mils |
| | (0.03 mm). |
| Testing Tape 2 | Included an adhesive as described in |
| | U.S. Pat. No. 6,197,397 (column 15, PSA |
| | solution 10) |
| Karstedt's Catalyst | A platinum-divinyltetramethyldisiloxane complex |
| | in xylene, containing between 2.1 and 2.4 |
| | weight percent (wt-%) platinum |
| | concentration (concentration of pure platinum |
| | metal), obtained under the product code |
| | SIP6831.2 from Gelest, Morrisville, PA. |
| AC30 + HA | A mixture of alpha olefins containing at least 95.5 |
| | wt-% of olefins having a carbon number of |
| | C30 or more, obtained under the trade |
| | designation ALPHAPLUS C30 + HA from |
| | Chevron Phillips Chemical Company LP, |
| | The Woodlands, TX. |
| AC26-28 | A mixture of alpha olefins containing 54 wt-% |
| | of C26 olefins and 36% of C28 olefins, |
| | obtained under the trade designation |
| | ALPHAPLUS C26-28 from Chevron Phillips |
| | Chemical Company LP, The Woodlands, TX. |
| BEA 1822 | A mixture of C18, C20 and C22 acrylates, |
| | obtained under trade designation Behenyl |
| | Acrylate 1822 from BASF, Florham Park, |
| | New Jersey. |
| 1-Octene | 1-Octene, obtained from Sigma Aldrich Chemical |
| | Company, Milwaukee, WI. |
| LDPE pellets | Low density polyethylene pellets with melt |
| | index of 5.6 obtained under the product code |
| | NA217000 from Lyondell Basell, Houston TX. |

### Test Methods

Initial Peel Adhesion Strength

Peel adhesion strength was measured at an angle of 180° using an IMASS SP-200 slip/peel tester (IMASS, Incorporated, Accord, Mass.) at a peel rate of 229 centimeters/minute (90 inches/minute). Glass test panels measuring 25.4 centimeters by 12.7 centimeters (10 inches by 5 inches) were cleaned by wiping them with isopropanol using a lint-free tissue and allowing them to air dry for 30 minutes after which they were clamped to the test stage of the peel tester. Tape samples measuring approximately 1.3 centimeters by 20 centimeters (0.5 inch by 8 inches) were then applied to the cleaned test panels with the adhesive side in contact with the test panel. The tape samples were then rolled over using a 2.0-kilogram (4.5-pound) rubber roller one time forward and backward. The taped panels were stored and tested at 23° C. and 50% relative humidity (RH). Testing was conducted between 1 and 8 hours after preparation. Three to five taped panels were evaluated and the average peel adhesion strength of the total number of panel tested was reported. Results were obtained in grams/inch and converted to Newtons/decimeter (N/dm). In addition, it was noted if any adhesive residue remained on the glass panel after removal of the tape sample.

Release Force

The 180° angle release force of a release liner to an adhesive sample was measured in the following manner. The indicated tested tape was applied to polyethylene films (with or without additives) constructions with the adhesive of the tape in contact with the polyethylene films (with or without additives). The resulting laminates were then rolled over using a 2.0-kilogram (4.5-pound) rubber roller one time forward and backward and aged for 7 days at 23° C. or 50° C. and 50% relative humidity (RH) prior to testing for release adhesion strength. Next, a double-sided foam tape (3M Double Coated Urethane Foam Tape 4008, a 0.125-inch-thick open-cell, flexible urethane foam tape, obtained from 3M Company, Maplewood, Minn) was applied to the platen of a peel tester (Slip/Peel Tester, Model 3M90, Instrumentors, Incorporated, Strongsville, Ohio). A sample of the release liner/tape laminate, measuring 2.54 centimeters by approximately 20 centimeters (1 inch by 8 inches), was then applied to the exposed foam tape surface such that the exposed surface of the tape contacted the foam tape. This was rubbed down using light thumb pressure followed by rolling over it with a 2.0-kilogram (4.5-pound) rubber roller one time forward and backward. The tape was then removed from the release liner at an angle of 180° at a rate of 229 centimeters/minute (90 inches/minute). Results were obtained in grams/inch and converted to Newtons/decimeter (N/dm). Three to five laminates were evaluated and the average release adhesion strength of the total number of laminates tested was reported. Testing was done at 23° C. or 50° C. (as indicated in the tables) and 50% RH. Release force results are summarized in Tables 3-6.

Re-adhesion Peel Strength and (%) Retention of Initial Peel Strength

The effect of extractable materials in the release coating of the release liners on the peel adhesion strength of adhesive tapes which contacted the liners was evaluated as follows. After evaluating release liners for their release force, the tape was removed from the foam tape and evaluated for its re-adhesion peel strength as described the “Initial Peel Adhesion Strength” test method above. The adhesive layer of the tape was applied to the glass test panel.

In addition, a tape sample not previously contacted with the polyethylene films (with or without additives) described herein was also evaluated for its peel adhesion strength. These results were recorded as “Initial Peel Adhesion Strength”. This test was a measure of the effect of any extractable transferred from the polyethylene films (with or without additives) to the adhesive layer of the tape on the peel adhesion strength of the tape.

It is desirable that there be minimal differences between the initial and re-adhesion peel strength values. Readhesion peel strengths were used to calculate a % Retention value as follows: Percent Retention=(Readhesion Peel Strength/Initial Peel Adhesion Strength)×100.

### Examples

Additive 1. Preparation of C30+ Adduct of PDMS 4

AC30+HA, 344 grams, was added at room temperature to a 1000 milliliter round bottom flask equipped with a condenser and heated at 100° C. until all the material was melted. Next, a mixture of 100 grams PDMS 4 and 0.25 grams of Karstedt's Catalyst was added to the flask at 100° C. followed by stirring for twelve hours. The reaction was monitored by FT-IR until the Si—H absorbance disappeared. The reaction mixture was then vacuum stripped at 150° C. for one hour to give 430 grams of off-white product.

Additive 2. Preparation of C30+ Adduct of PDMS 3

AC30+HA, 137 grams, was added at room temperature to a 500 milliliter round bottom flask equipped with a condenser and heated at 100° C. until all the material was melted. Next, a mixture of 100 grams PDMS 3 and 0.25 grams of Karstedt's Catalyst was added to the flask at 100° C. followed by stirring for twelve hours. The reaction was monitored by FT-IR until the Si—H absorbance disappeared. The reaction mixture was then vacuum stripped at 150° C. for one hour to give 230 grams of off-white product.

Additive 3. Preparation of C30+ Adduct of PDMS 2

AC30+HA, 27.5 grams, was added at room temperature to a 500 milliliter round bottom flask equipped with a condenser and heated at 100° C. until all the material was melted. Next, a mixture of 100 grams PDMS 2 and 0.25 grams of Karstedt's Catalyst was added to the flask at 100° C. followed by stirring for twelve hours. The reaction was monitored by FT-IR until the Si—H absorbance disappeared. The reaction mixture was then vacuum stripped at 150° C. for one hour to give 122 grams of off-white product.

Additive 4. Preparation of C30+ Adduct ofPDMS 1

AC30+HA, 7.0 grams, was added at room temperature to a 500 milliliter round bottom flask equipped with a condenser and heated at 100° C. until all the material was melted. Next, a mixture of 100 grams PDMS 1 and 0.25 grams of Karstedt's Catalyst was added to the flask at 100° C. followed by stirring for twelve hours. The reaction was monitored by FT-IR until the Si—H absorbance disappeared. The reaction mixture was then vacuum stripped at 150° C. for one hour to give 104 grams of off-white product.

Additive 5. Preparation of C30+ Adduct of PDMS 5

AC30+HA, 15 grams, was added at room temperature to a 1000 milliliter round bottom flask equipped with a condenser and heated at 100° C. until all the material was melted. Next, a mixture of 100 grams PDMS 5 and 0.25 grams of Karstedt's Catalyst was added to the flask at 100° C. followed by stirring for twelve hours. The reaction was monitored by FT-IR until the Si—H absorbance disappeared. The reaction mixture was then vacuum stripped at 150° C. for one hour to give 110 grams of off-white product.

Additive 6. Preparation of C26-28 Adduct of PDMS 3

AC26-28, 76 grams, was added at room temperature to a 500 milliliter round bottom flask equipped with a condenser and heated at 100° C. until all the material was melted. Next, a mixture of 100 grams PDMS 3 and 0.25 grams of Karstedt's Catalyst was added to the flask at 100° C. followed by stirring for twelve hours. The reaction was monitored by FT-IR until the Si—H absorbance disappeared. The reaction mixture was then vacuum stripped at 150° C. for one hour to give 168 grams of off-white product.

Additive 7. Preparation of BEA 1822 Adduct of PDMS 6

BEA 1822, 14.5 grams, was added at room temperature to a 500 milliliter round bottom flask equipped with a condenser and heated at 70° C. until all the material was melted. Next, 100 grams of PDMS 6 was added to the flask at 70° C. followed by stirring for twelve hours. The reaction mixture was then vacuum stripped at 150° C. for one hour to give 110 grams of product.

Additive 8. Preparation of C30+ Adduct of PDMS 7

AC30+HA, 2.25 grams, was added at room temperature to a 500 milliliter round bottom flask equipped with a condenser and heated at 100° C. until all the material was melted. Next, a mixture of 100 grams PDMS 1 and 0.25 grams of Karstedt's Catalyst was added to the flask at 100° C. followed by stirring for twelve hours. The reaction was monitored by FT-IR until the Si—H absorbance disappeared. The reaction mixture was then vacuum stripped at 150° C. for one hour to give 96 grams of off-white product.

Comparative Additive 9: C30+ Adduct of PMHS

PMHS (639 grams) having pendent, rather than terminal hydride(s) and AC30+HA (249 grams) were mixed with 245 mL of toluene in a 2000 mL flask at 70° C. Thereafter, 300 microliters of Karstedt catalyst was added to the mixture followed by stirring for 19 hours. 1-Octene (59.4 grams) was added to the mixture and the solution was stirred for 4.5 hours at 90° C. The adduct was obtained after removing the toluene at 80° C. for 24-48 hours.

Preparation of Extruded Films with Release Additives

LDPE pellets were fed to a 25-milimeter twin screw extruder having an intensive mixing screw design and zones 1-6 held at following temperatures, 190° C., 204.5° C., 232° C., 249° C., 255° C., and 260° C. respectively. Block Copolymer Additives 1-8 and Comparative Additive 9 were fed via a heated syringe pump in liquid form at a constant rate into the extruder in the indicated weight percent (Table 2). The melt was extruded through a die at a total throughput of 3628 grams per hour to afford films of 2-mils (0.005 centimeter (cm) thickness). The composition and amount of silicone additive in the films is shown in Table 2. Control example CT1 was LDPE pellets extruded alone without any additive.

TABLE 2
Composition and amount of silicone adduct in the film

| | | Amount of additive |
|---|---|---|
| | | in LDPE |
| | | pellets (wt % with |
| | | respect to |
| Example # | Additive # | Polyethylene) |
| CT1 | None | None |
| CE1 | Comparative Additive 9 | 3% |
| | with pendent alkyl | |
| | groups | |
| E1 | Additive 1 | 1% |
| E2 | Additive 1 | 2% |
| E3 | Additive 1 | 3% |
| E4 | Additive 1 | 4% |
| E5 | Additive 2 | 1% |
| E6 | Additive 2 | 2% |
| E7 | Additive 2 | 3% |
| E8 | Additive 2 | 4% |
| E9 | Additive 3 | 2% |
| E10 | Additive 3 | 3% |
| E11 | Additive 4 | 2% |
| E12 | Additive 4 | 3% |
| E13 | Additive 5 | 2% |
| E14 | Additive 5 | 3% |
| E15 | Additive 6 | 2% |
| E16 | Additive 6 | 3% |
| E17 | Additive 7 | 3% |
| E18 | Additive 8 | 3% |

TABLE 3
Release data aged at 23° C. for 7 days

| | Tape 850, | Peel |
|---|---|---|
| | grams/inch | Retention, |
| Example # | (Newton/dm) | % |
| CT1 | 212.6 (312.5) | 100 |
| E1 | 92.6 (147.5) | 98 |
| E2 | 73.8 (132.7) | 105 |
| E3 | 58.5 (103.9) | 100 |
| E4 | 64.6 (123.3) | 100 |
| E5 | 60.8 (93.6) | 103 |
| E6 | 45.5 (85.6) | 99 |
| E7 | 36.0 (80.3) | 102 |
| E8 | 39.1 (79.6) | 100 |
| E9 | 38.1 (30.5) | 95 |
| E10 | 38.0 (29.0) | 97 |
| E11 | 23.0 (25.2) | 98 |
| E12 | 18.5 (16.8) | 98 |
| CE1 | 11.7 (13.9) | 74.3 |
| E13 | 45.1 (50.3) | 95 |
| E14 | 40.0 (49.3) | 96 |
| E15 | 85.5 (39.4) | 97 |
| E16 | 84.0 (37.3) | 92 |
| E17 | 155 (170.5) | 74 |
| E18 | 77 (84.7) | 96 |

TABLE 4
Release data aged at 50° C. for 7 days

| | Tape 850, | Peel |
|---|---|---|
| | grams/inch | Retention, |
| Example # | (Newton/dm) | % |
| CT1 | 284.1 (312.51) | 100 |
| E1 | 134.1 (147.5) | 100 |
| E2 | 120.6 (132.7) | 100 |
| E3 | 119.0 (130.9) | 101 |
| E4 | 112.1 (123.3) | 99 |
| E5 | 85.1 (93.6) | 100 |
| E6 | 77.8 (85.6) | 99 |
| E7 | 73.0 (80.3) | 103 |
| E8 | 72.4 (79.6) | 97 |
| E9 | 27.7 (30.5) | 95 |
| E10 | 26.4 (29.0) | 93 |
| E11 | 22.9 (25.2) | 94 |
| E12 | 15.3 (16.8) | 91 |
| CE1 | 12.6 (13.9) | 58 |
| E13 | 45.7 (50.3) | 85 |
| E14 | 44.8 (49.3) | 83 |
| E15 | 35.8 (39.4) | 86 |
| E16 | 33.9 (37.3) | 84 |
| E17 | 232 (255.2) | 66 |
| E18 | 140 (154) | 98 |

TABLE 5
Release data aged at 23° C. for 7 days

| | Testing Tape 1, | Peel | Testing Tape 2, | Peel |
|---|---|---|---|---|
| | grams/inch | Retention, | grams/inch | Retention, |
| Example # | (Newton/dm) | % | (Newton/dm) | % |
| CT1 | 447.0 (491.7) | 100 | 203.0 (223.3) | 100 |
| E3 | 345.4 (379.9) | 99 | 156.0 (171.6) | 99 |
| E7 | 237.7 (261.5) | 97 | 97.5 (107.3) | 98 |
| E10 | 117.0 (128.7) | 95 | 85.8 (94.4) | 100 |
| E11 | 68.0 (74.8) | 93 | 79.1 (87.0) | 100 |
| E12 | 47.3 (52.0) | 90 | 77.5 (85.3) | 100 |
| E17 | 240 (264) | 55 | N/A (N/A) | N/A |
| CE1 | 18.3 (20.1) | 49 | N/A (N/A) | N/A |

N/A = Not applicable

TABLE 6
Release data aged at 50° C. for 7 days

| | Testing Tape 1, | Peel | Testing Tape 2, | Peel |
|---|---|---|---|---|
| | grams/inch | Retention, | grams/inch | Retention, |
| Example # | (Newton/dm) | % | (Newton/dm) | % |
| CT1 | 400.8 (440.9) | 100 | 594.2 (653.6) | 100 |
| E3 | 161.5 (177.7) | 95 | 218.2 (240.0) | 93 |
| E7 | 54.7 (60.2) | 97 | 121.9 (134.1) | 97 |
| E10 | 53.0 (58.3) | 93 | 114.4 (125.8) | 96 |
| E11 | 50.9 (56.9) | 88 | 113.6 (125.0) | 95 |
| E12 | 45.5 (50.1) | 85 | 102.0 (112.2) | 93 |
| E17 | 345 (379.5) | 50 | N/A (N/A) | N/A |
| CE1 | 19.8 (21.8) | 23 | N/A (N/A) | N/A |

N/A = Not applicable

1. A pressure sensitive adhesive article comprising:
a release layer and a pressure sensitive adhesive in contact with the release layer;
wherein the release layer comprises a thermoplastic polymer; and a block copolymer additive having the general structure:
A[LB]n
wherein
A is a polyorganosiloxane block,
L is a covalent bond or a divalent linking group
B is independently a C16-C70 alkyl group, and
n is at least 1.

2. The pressure sensitive adhesive article of claim 1 wherein the thermoplastic polymer is a polyolefin.

3. The pressure sensitive adhesive article of claim 2 wherein the release layer comprises at least 90% polyethylene.

4. The pressure sensitive adhesive article of claim 1 wherein the thermoplastic polymer has a melt index of less than 20, 15, 10, or 5 g/10 min at 190° C.

5. The pressure sensitive adhesive article of claim 1 wherein the release layer comprises no greater than 10% block copolymer additive.

6. The pressure sensitive adhesive article of claim 1 wherein the polyorganosiloxane block has a molecular weight ranging from 200 to 200,000 g/mole.

7. The pressure sensitive adhesive article of claim 1 wherein the alkyl groups of the block copolymer additive have less than 30 contiguous carbon atoms.

8. The pressure sensitive adhesive article of claim 1 wherein the block copolymer additive comprises linear and branched alkyl groups.

9. The pressure sensitive adhesive article of claim 1 wherein the alkyl groups of the block copolymer additive comprise 1-96 wt. % of alkyl groups having at least 30 contiguous carbon atoms.

10. The pressure sensitive adhesive article of claim 9 wherein the alkyl groups of the block copolymer additive comprise 1-10 wt. % of alkyl group having at least 30 contiguous carbon atoms and at least 90-99 wt. % of alkyl groups having 26-28 contiguous carbon atoms.

11. The pressure sensitive adhesive article of claim 9 wherein the alkyl groups of the block copolymer additive comprise 1-10 wt. % of alkyl groups having 24-28 contiguous carbon atoms and at least 90-99 wt. % of polyolefins having at least 30 contiguous carbon atoms.

12. The pressure sensitive adhesive article of claim 1 wherein the release layer has a release force to a pressure sensitive adhesive tape at least 50% less than the thermoplastic polymer alone or the release layer has re-adhesion peel retention of at least 50% when aged at 50° C. for 7 days and tested with iso-octyl acrylate-acrylic acid (90:10) copolymer adhesive at a thickness of 0.03 mm on a 0.05 mm polypropylene backing.

13. (canceled)

14. A composition comprising
thermoplastic polymer; and
up to 50 wt. % of a block copolymer additive; wherein the block copolymer additive has the general structure:
A[LB]n
wherein
A is a polyorganosiloxane block,
L is a covalent bond or a divalent linking group,
B is independently a C16-C70 alkyl group, and
n is at least 1.

15. A composition comprising
thermoplastic polymer; and
up to 50 wt. % block copolymer additive;
wherein the block copolymer additive is the reaction product of a polydiorganosiloxane polymer comprising a terminal functional group and an olefin material having a specific gravity no greater than 0.89.

16. The composition of claim 15 wherein the olefin material is an alpha olefin material or functional polyolefin material.

17. The composition of claim 15 wherein the olefin material has a specific gravity of no greater than 0.88, 0.87, 0.86, 0.85, 0.84, 0.83, 0.82, or 0.81 g/cc.

18. The composition of claim 15 wherein the olefin material is a solid at 15, 20, 25, 30, 35 or 40° C.

19. The composition of claim 16 wherein the alpha olefin material has a congealing point of at least 120, 130, 140 or 150° F.

20. The composition of claim 15 wherein the olefin material comprises at least 5, 10, or 15 wt. % of branched alkyl groups.

21-22. (canceled)

23. A block copolymer having the general structure:
A[LB]n
wherein
A is a polyorganosiloxane block,
L is a covalent bond or a divalent linking group
B is independently a C16-C70 alkyl group, and
n is at least 1; wherein the block copolymer is further characterized by claim 6.

24. The block copolymer of claim 23 wherein the polyorganosiloxane block has a molecular weight of at least 10,000 g/mole or 15,000 g/mole.
